(19) United States
(12) Patent Application Publication
(10) Pub. No.: US 2024/0417948 A1
(43) Pub. Date: Dec. 19, 2024

(54) ON-SITE ASSEMBLED HANDHOLES

(71) Applicant: AFL Telecommunications LLC, Duncan, SC (US)

(72) Inventor: Mark Vogel, Greenville, SC (US)

(21) Appl. No.: 18/702,906

(22) PCT Filed: Oct. 20, 2022
(86) PCT No.: PCT/US2022/047246

§ 371 Date: Apr. 19, 2024

Related U.S. Application Data
(60) Provisional application No. 63/270,937, filed on Oct. 22, 2021.

(51) Int. Cl. E02D 29/12

(52) U.S. Cl. CPC E02D 29/12

(57) ABSTRACT

A handhole is provided, the handhole including a first wall and a second wall. The first wall includes a first joint portion forming a groove and an opening extending along a vertical direction. The second wall includes a second joint portion including a member extendable into the groove through the opening at the first joint portion. The first wall and the second wall are connectable together at the first joint portion and the second joint portion.

PRIORITY STATEMENT

The present application claims the benefit of priority to U.S. Provisional Patent Application Ser. No. 63/270,937, filed on Oct. 22, 2021, the disclosure of which is incorporated by reference herein in its entirety.

### FIELD

The present disclosure relates generally to structures for handholes for use in various industries such as telecommunications, water, or energy.

### BACKGROUND

A significant problem with large telecommunication handholes are their bulky sizes and large weight as it relates to storage, shipping, and installation of the handhole. Installation often involves either multiple users to install the handhole or the use of heavy equipment (e.g., backhoe) to place the handhole into the ground.

Accordingly, improved handholes would be advantageous. Specifically, handholes which address one of more of the above-stated deficiencies would be advantageous.

### BRIEF DESCRIPTION

Aspects and advantages of the invention will be set forth in part in the following description, or may be understood from the description, or may be learned through practice of the invention.

An aspect of the present disclosure is directed to a handhole. The handhole includes a first wall and a second wall. The first wall includes a first joint portion forming a groove and an opening extending along a vertical direction. The second wall includes a second joint portion including a member extendable into the groove through the opening at the first joint portion. The first wall and the second wall are connectable together at the first joint portion and the second joint portion.

Another aspect of the present disclosure is directed to a handhole assembly. The handhole assembly includes a pair of first walls and a pair of second walls. The first wall includes a first joint portion forming a groove and an opening extending along a vertical direction. The second wall includes a second joint portion including a member extendable into the groove through the opening at the first joint portion. The first wall and the second wall are connectable together at the first joint portion and the second joint portion to form a tongue and groove joint at which the first wall and the second wall are directly coupled to one another.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a perspective view of an exemplary embodiment of a handhole structure including equipment in accordance with aspects of the present disclosure;

FIG. 2 depicts a perspective disassembled view of an exemplary embodiment of a handhole structure in accordance with aspects of the present disclosure;

FIG. 3 depicts a perspective assembled view of an exemplary embodiment of a handhole structure in accordance with aspects of the present disclosure;

FIG. 4 depicts a perspective assembled view of an exemplary embodiment of a handhole structure in accordance with aspects of the present disclosure;

FIG. 5 depicts a top-down view of an exemplary embodiment of a joint at the handhole structure in accordance with aspects of the present disclosure;

FIG. 6 depicts a perspective view illustrating assembly of an exemplary embodiment of the joint at the handhole structure in accordance with aspects of the present disclosure;

FIG. 7 depicts a perspective view illustrating assembly of an exemplary embodiment of the joint at the handhole structure in accordance with aspects of the present disclosure;

FIG. 8 depicts a perspective view illustrating an exemplary embodiment of the joint at the handhole structure in accordance with aspects of the present disclosure; and

FIG. 9 depicts a perspective view of an exemplary embodiment of the joint at the handhole structure in accordance with aspects of the present disclosure cut at a first wall along plane 9-9.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

Handholes in accordance with various embodiments of the present disclosure may further include one or more features as disclosed in International Patent Application No. WO 2021/146472A1; U.S. Pat. Nos. 11,008,134; 11,066,802; U.S. patent application Ser. No. 17/223,089; U.S. patent application Ser. No. 17/224,155; and/or U.S. patent application Ser. No. 17/322,120, the disclosures of all of which is incorporated by reference herein in their entireties.

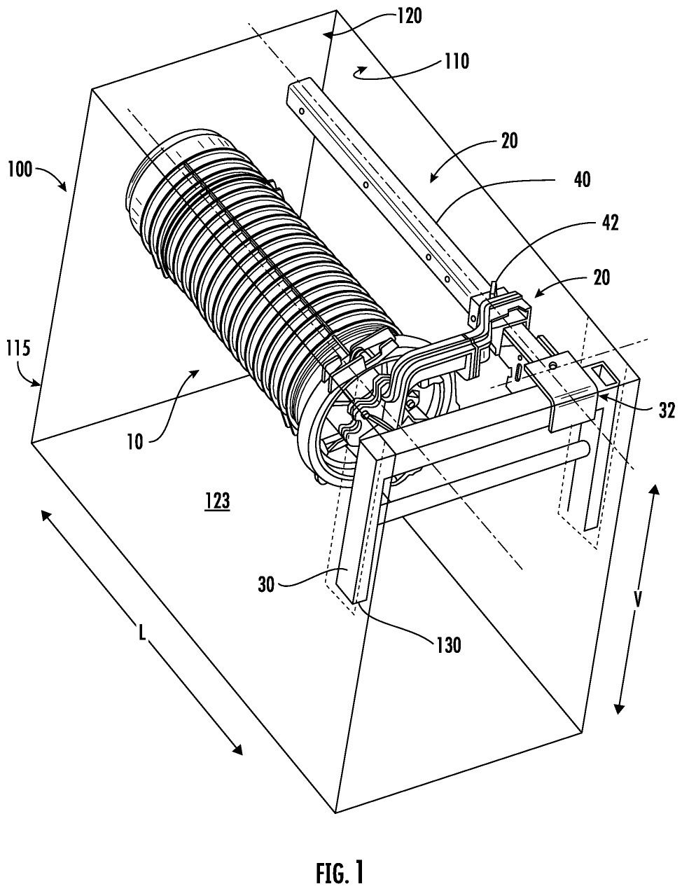

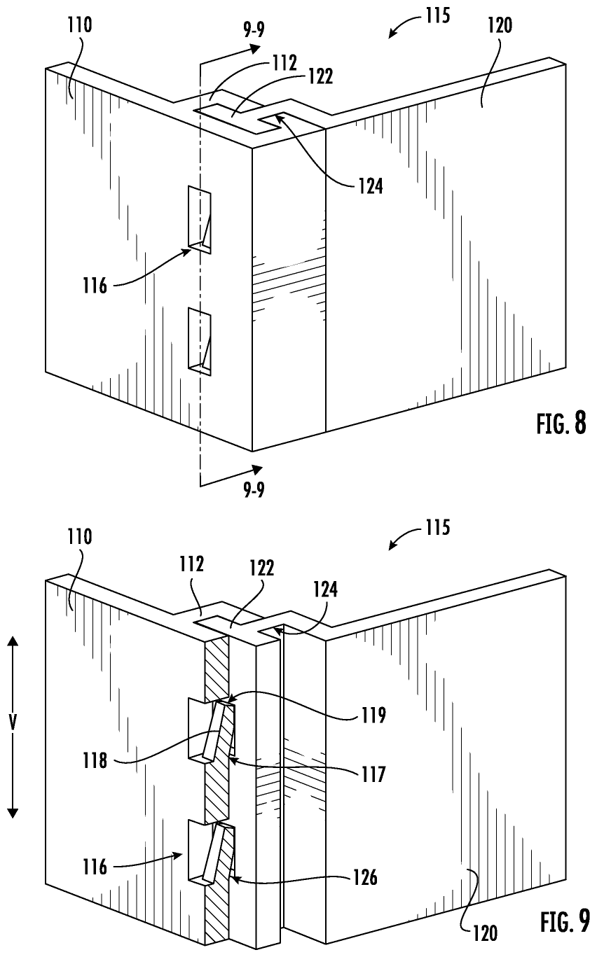

Referring now to the drawings, FIGS. 1-9 illustrate embodiments of a handhole structure (hereinafter, “handhole 100”). Embodiments of the handhole 100 may be used with equipment 10, such as enclosures for telecommunications equipment (e.g., Apex^{™} Fiber Optic Closures or other appropriate type telecommunications closure), water or power meters, regulators, or other equipment for telecommunications, water, or energy industries. The handhole 100 forms a volume into which the equipment 10 may be positioned. For instance, the handhole 100 may be placed into the ground (e.g., an underground handhole) and the equipment may be positioned into the volume formed by the handhole 100.

Referring to FIGS. 1-9, the handhole 100 includes a first wall 110 selectively connectable to a second wall 120. The first wall 110 and the second wall 120 are connectable together at a joint 115, such as further depicted and described herein. Referring to FIG. 1, the equipment 10 may be mounted to the handhole 100 via a mount assembly 20. The mount assembly 20 may include a bracket 42 configured to connect the equipment 10 to a mount member 40. The mount member 40 may include a rail, rod, beam, or other structural member configured to hold and support the equipment 10. For instance, the bracket 42 may attach to the mount member 40 and extend from the mount member 40, such as to position the equipment 10 along a separate axis from the mount member 40. The bracket 42 may be configured to hold the equipment 10 in cantilevered arrangement from the mount member 40. In some embodiments, the mount assembly 20 may include a plurality of brackets 42 configured to extend from the mount member 40 to the equipment 10, such as to hold the equipment at a plurality of locations.

Referring still to FIG. 1, the mount assembly 20 may include a mount base 30. The mount base 30 is configured to connect to the handhole 100, such as to allow the equipment 10 to be supported by the handhole 100 within the volume formed in the handhole 100. In some embodiments, the mount assembly 20 may include a coupler 32. The coupler 32 is configured to connect the mount member 40 to the mount base 30. In various embodiments, the coupler 32 may retain the mount member 40 to the mount base 30 in a stationary arrangement. In other embodiments, the coupler 32 may be configured to selectively rotate, such as to position the equipment 10 from extending along a longitudinal direction L (such as depicted in FIG. 1) to extending along a vertical direction V orthogonal to the longitudinal direction L and transverse direction T, or to one or more angles therebetween.

In an exemplary embodiment, the handhole 100 includes the first wall 110 extending along a longitudinal direction, such as extending co-directional to a lengthwise extension or height of the equipment 10. The handhole 100 may include the second wall 120 extending along the transverse direction T, such as extending substantially perpendicular to the longitudinal direction L, or extending co-directional to the bracket 42 extending along the transverse direction T from the mount member 40. The handhole 100 may include two or more first wall 110 positioned substantially parallel to one another. The handhole 100 may include two or more second wall 120 positioned substantially parallel to one another. The first wall 110 and the second wall 120 may be positioned substantially perpendicular to one another at joint 115.

First wall 110 may form an attachment surface 130 at which the mount base 30 is attachable. For instance, the attachment surface 130 may include a groove or recess extending into the first wall 110, or a protrusion or projection (e.g., a rail or track), at which the mount base 30 may slide or otherwise position. The attachment surface 130 may extend along the vertical direction. The attachment surface 130 may extend partially or entirely along the first wall 110, such as from top to bottom, or to or from any point between the top and bottom. In various embodiments, the mount base 30 may be affixed to the handhole 100 via a fastener, such as a screw; bolt, tie rod, clamp, latch, or appropriate mechanical fastener.

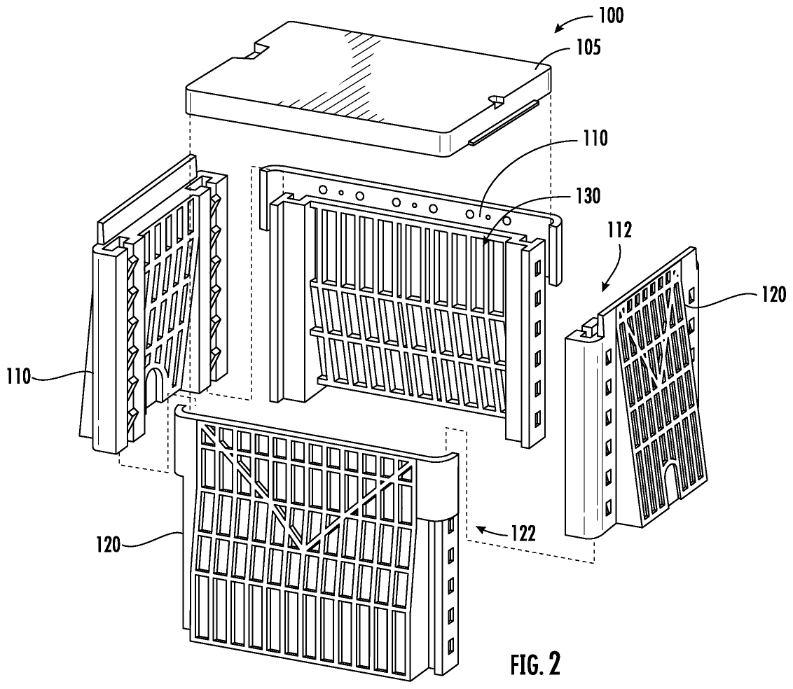

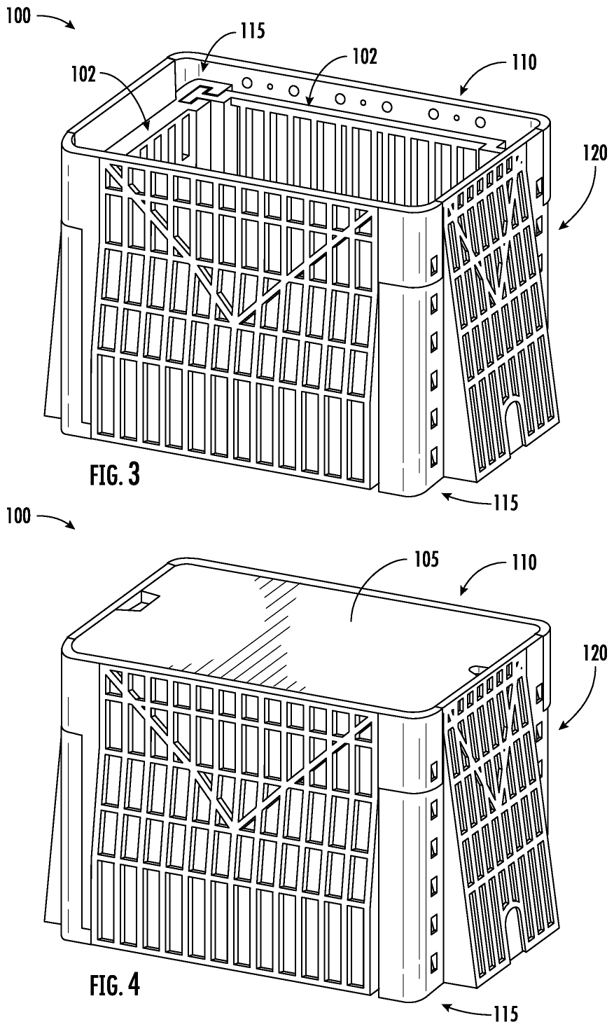

Referring now to FIG. 2, a deconstructed view of an embodiment of a handhole 100 is depicted. FIGS. 3-4 provide perspective views of embodiments of the handhole 100 in an assembled state. In some embodiments, the handhole 100 may include an upper cover 105. Referring to FIGS. 2-4, the upper cover 105 may be configured to rest onto the first wall 110, the second wall 120, or both. In some embodiments, the first wall 110, the second wall 120, or both, form a platform 102 extending into the volume formed by the first wall 110 and the second wall 120. The platform 102 may be positioned proximate to an upper lip 104 of the first wall 110, the second wall 120, or both. In general, the platform 102 may be positioned along the vertical direction higher than the equipment 10 (FIG. 1) when the equipment 10 is positioned extending along the longitudinal direction (such as depicted in FIG. 1). The upper cover 105 may be configured to rest upon the platform 102 and form a surface flush or co-directional with the ground, such as may be walked-upon by pedestrians. The upper cover 105 may additionally, or alternatively, form a seal configured to mitigate fluid communication or particulate movement into the volume formed by the first wall 110 and the second wall 120.

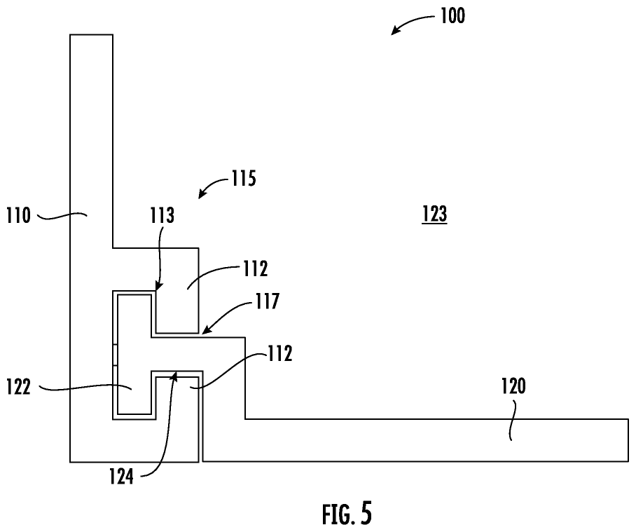

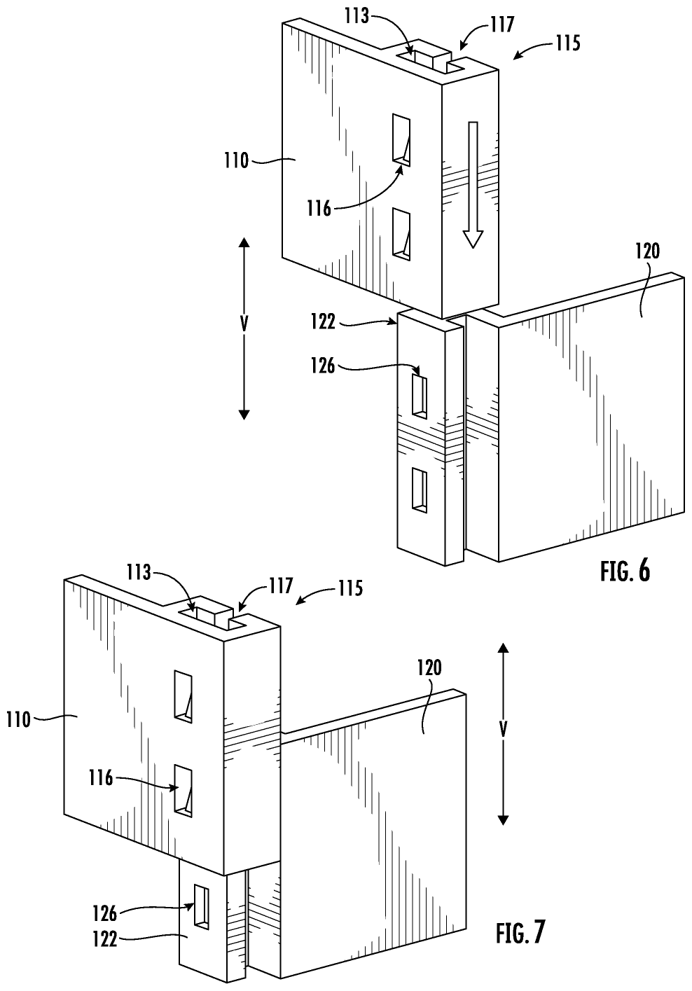

Referring now to FIGS. 5-9, views depicting exemplary embodiments of the joint 115 are provided at which the first wall 110 and the second wall 120 are attached to one another. FIG. 5 provides a top-down view of an exemplary embodiment of the joint 115. FIGS. 6-9 provide perspective views of an exemplary embodiment of the joint 115. The first wall 110 includes a first joint portion 112 forming a slot or groove 113. The first wall 110 forms an opening 117 into the groove 113. In particular embodiments, the first joint portion 112 forms the opening 117 as a slot extending from the volume to the groove 113 The second wall 120 includes a second joint portion 122 configured to extend through an opening 117 formed at the first wall 110 and into the groove 113. The second wall 120 may include a neck 124 extending through the opening 117. The opening 117 may extend along the vertical direction V, such as to form a slot along which the second joint portion 122 may extend through the groove 113. The second joint portion 122 may form walls extending into the groove 113, such as to form a tongue, lock, or key that restricts movement of the second wall 120, such as to couple the first wall 110 and the second wall 120 together at the joint 115.

FIGS. 6-9 illustrate steps of a method for assembling a handhole structure in accordance with aspects of the present disclosure. The second joint portion 122 is positioned into the groove 113 at the first joint portion 112, such as via aligning the first wall 110 and the second wall 120 and moving one or both of the first wall 110 or the second wall 120 along the vertical direction V to slide the second joint portion 122 into the groove 113.

In some embodiments, the second wall 120 may be positioned in a hole dug into the ground at which the handhole 100 will be positioned. The first wall 110 may be positioned to slide the groove 113 around the second joint portion 122 and have the neck 124 extend through the opening 117. The second joint portion 122 may be secured within the groove 113, such as to restrict movement or separation of the walls 110, 120 from one another (e.g., along the longitudinal direction L, the transverse direction T, or angles therebetween).

In another embodiment, the first wall 110 may be positioned in a hole dug into the ground at which the handhole 100 will be positioned. The second wall 120 may be positioned to slide the second joint portion 122 along the vertical direction through the groove 113.

Referring to FIGS. 6-9, in some embodiments, the handhole 100 may include a locking mechanism 116. The second wall 120 may include a lock opening 126 configured to receive a tab 118 from the first wall 110. In some embodiments, the lock opening 126 is formed at the second joint portion 122. The second joint portion 122 may form one or more discrete slots or openings 126, such as a plurality of lock openings 126 in adjacent arrangement along the vertical direction V.

The first wall 110 may form the tab 118 as a portion of compliant material configured to deflect or spring into the lock opening 126. In some embodiments, the tab 118 is configured to angle from the vertical direction V and spring or deflect into the lock opening 126 as the second joint portion 122 translates along the vertical direction V relative to the groove 113. The first wall 110 may form the tab 118 at the first joint portion 112. In some embodiments, the tab 118 is configured to extend into the groove 113 formed at the first joint portion 112. The first wall 110 may form the tab 118 as one or more discrete tabs 118, such as a plurality of tabs 118 in adjacent arrangement along the vertical direction V. The tab 118 may correspond to location along the vertical direction V to a respective lock opening 126.

In still some embodiments, the tab 118 may be configured to angle such that an upper end 119 is positioned toward the lock opening 126 and a lower end 117 is attached to the first wall 110. The tab 118 may allow for unidirectional translation of the first wall 110 downward along the vertical direction V. Accordingly, the lower end 117 of the tab 118 contacts the second joint portion 122 at the lock opening 126 before the upper end 119 of the tab 118. The upper end 119 of the tab 118 may inhibit movement of the first wall 110 upward along the vertical direction V, such as to secure the first wall 110 and the second wall 120 to one another along the vertical direction V.

In other embodiments, a fastener, such as, but not limited to, a screw, bolt, nut, nail, tie rod, or other mechanical fastener, may extend through the first wall 110 and the second wall 120, such as at joint 115, to fasten the walls 110, 120 together.

Embodiments of the first wall 110 and the second wall 120 depicted herein (e.g., in FIGS. 1-4) may depict the first wall 110 extending along the longitudinal direction L for a dimension greater than the second wall 120 extending along the transverse direction T. However, it should be appreciated that various embodiments of the handhole 100 may include the first wall 110 extending along the transverse direction T and the second wall 120 extending along the longitudinal direction L. Embodiments of the handhole 100 may be arranged in any appropriate polygonal configuration, such as a substantially square, rectangular, or trapezoidal arrangement of the first wall 110 and the second wall 120.

Embodiments of the walls 110, 120, including the joint 115, may be formed of a polymer material. The handhole 100 may include thermoplastic polymers, such as, but not limited to, a polyethylene (e.g., high-density polyethylene, or HDPE), a polycarbonate, a polypropylene, or a polyamide material, or combinations thereof. One or more of the first wall 110 or the second wall 120 may be formed from any appropriate manufacturing process, such as injection molding, compression molding, or structural foam molding.

In some embodiments, the first wall 110 and the second wall 120 are each separate respective unitary structures joined directly together at the joint 115. The first joint portion 112 and the second joint portion 122 may be configured as any appropriate engineering fit, such as, but not limited to, sliding fits or running fits.

Various embodiments of the handhole 100 may directly couple the first wall 110 to the second wall 120 via the joint 115 such as described herein. Embodiments of the walls 110, 120 coupled together at the joint 115 such as provided herein may allow the walls 110, 120 to receive stresses and loads, in contrast to coupling walls together via hinges and pins. As such, stresses and loads may be distributed across greater portions of the handhole 100, such as across the walls 110, 120, in contrast to concentration at an interface at which the walls are coupled. Such embodiments of the handhole 100 may mitigate or eliminate a need for a cross-brace extending across pairs of walls.

Embodiments of the handhole 100 may further allow a user to transport the walls 110, 120 to a worksite (e.g., the location at which the handhole and equipment will be placed, such as into the ground) in pieces (e.g., four pieces), in contrast to cumbersome unitary bodies, folding structures, shells, or subassemblies. Embodiments of the handhole 100 may allow a user to desirably change handhole dimensions, such as to change a dimension along the longitudinal direction L, the transverse direction T, or the vertical direction V, without requiring disassembly, adapters, or fastening components.

Embodiments provided herein may significantly reduce storage, shipping, and installation effort for handholes, such as due to allowing for transport of the first wall 110 and the second wall 120 separately, and assembly together at the worksite. Such embodiments may further provide transportation and assembly advantages while also providing improved structural integrity, such as by allowing loads to distribute across the walls rather than concentrate at the joints.

Further aspects of the invention are provided by the subject matter of the following clauses:
1. A handhole including a first wall including a first joint portion, the first joint portion forming a groove and an opening extending along a vertical direction; and a second wall including a second joint portion, the second joint portion including a member extendable into the groove through the opening at the first joint portion, wherein the first wall and the second wall are connectable together at the first joint portion and the second joint portion.
2. The handhole of any one or more clauses herein, wherein the first wall and the second wall are connectable together at the first joint portion and the second joint portion to form a joint at which the first wall and the second wall are directly coupled to one another.
3. The handhole of any one or more clauses herein, wherein the first wall and the second wall are connectable together by sliding the groove at the first joint portion over the second joint portion.
4. The handhole of any one or more clauses herein, wherein the first wall and the second wall are connectable together by sliding the groove along the vertical direction at the first joint portion over the second joint portion.
5. The handhole of any one or more clauses herein, wherein the second joint portion includes a tongue extendable into the groove at the first joint portion.
6. The handhole of any one or more clauses herein, including a locking mechanism including a lock opening at the second wall configured to receive a tab from the first wall.
7. The handhole of any one or more clauses herein, wherein the lock opening is formed at the second joint portion, and wherein the tab is formed at the first joint portion.
8. The handhole of any one or more clauses herein, wherein the lock opening at the second joint portion forms a slot along the vertical direction.
9. The handhole of any one or more clauses herein, wherein the second joint portion includes a plurality of lock openings in adjacent arrangement along the vertical direction.
10. The handhole of any one or more clauses herein, wherein the tab includes a compliant material configured to deflect into the lock opening.
11. The handhole of any one or more clauses herein, wherein the tab is configured to angle from the vertical direction and deflect into the lock opening as the second joint portion translates along the vertical direction relative to the groove.
12. The handhole of any one or more clauses herein, wherein the tab is configured to position an upper end toward the lock opening and a lower end attached to the first wall.
13. The handhole of any one or more clauses herein, wherein the lower end of the tab contacts the second joint portion at the lock opening before the upper end of the tab when the groove at the first wall is translated along the vertical direction around the second joint portion at the second wall.
14. The handhole of any one or more clauses herein, wherein the first wall and the second wall include a thermoplastic polymer.
15. The handhole of any one or more clauses herein, wherein the first wall is a unitary structure separate from the second wall forming a separate unitary structure.
16. The handhole of any one or more clauses herein, wherein the first wall includes an attachment surface, the attachment surface including a recess extending along the vertical direction.
17. The handhole of any one or more clauses herein, wherein the first wall includes an attachment surface, the attachment surface including a protrusion extending along the vertical direction.
18. The handhole of any one or more clauses herein, wherein one or both of the first wall or the second wall includes a platform extending into a volume formed by the first wall and the second wall.
19. A handhole assembly, including a pair of first walls, wherein the first wall includes a first joint portion, the first joint portion forming a groove and an opening extending along a vertical direction: and a pair of second walls, wherein the second wall includes a second joint portion, the second joint portion including a member extendable into the groove through the opening at the first joint portion, wherein the first wall and the second wall are connectable together at the first joint portion and the second joint portion to form a tongue and groove joint at which the first wall and the second wall are directly coupled to one another.
20. The handhole assembly of any one or more clauses herein, wherein the first wall and the second wall are connectable together by sliding the groove along the vertical direction at the first joint portion over the second joint portion.
21. A handhole assembly including the handhole of any one or more clauses herein.
22. The handhole assembly of any one or more clauses herein, the handhole assembly including a mount assembly coupled at an attachment surface to the handhole of any one or more clauses herein.
23. The handhole assembly of any one or more clauses herein, including a mount assembly coupled to the pair of first walls at respective attachment surfaces.
24. The handhole assembly of any one or more clauses herein, wherein the mount assembly includes a mount base extending across the pair of first walls at respective attachment surfaces.
25. The handhole assembly of any one or more clauses herein, wherein the attachment surface includes a groove, recess, protrusion, or projection extending along the vertical direction.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A handhole, comprising:
a first wall comprising a first joint portion, the first joint portion forming a groove and an opening extending along a vertical direction; and
a second wall comprising a second joint portion, the second joint portion comprising a member extendable into the groove through the opening at the first joint portion,
wherein the first wall and the second wall are connectable together at the first joint portion and the second joint portion.

2. The handhole of claim 1, wherein the first wall and the second wall are connectable together at the first joint portion and the second joint portion to form a joint at which the first wall and the second wall are directly coupled to one another.

3. The handhole of claim 1, wherein the first wall and the second wall are connectable together by sliding the groove at the first joint portion over the second joint portion.

4. The handhole of claim 3, wherein the first wall and the second wall are connectable together by sliding the groove along the vertical direction at the first joint portion over the second joint portion.

5. The handhole of claim 1, wherein the second joint portion comprises a tongue extendable into the groove at the first joint portion.

6. The handhole of claim 1, comprising:
a locking mechanism comprising a lock opening at the second wall configured to receive a tab from the first wall.

7. The handhole of claim 6, wherein the lock opening is formed at the second joint portion, and wherein the tab is formed at the first joint portion.

8. The handhole of claim 6, wherein the lock opening at the second joint portion forms a slot along the vertical direction.

9. The handhole of claim 6, wherein the second joint portion comprises a plurality of lock openings in adjacent arrangement along the vertical direction.

10. The handhole of claim 6, wherein the tab comprises a compliant material configured to deflect into the lock opening.

11. The handhole of claim 6, wherein the tab is configured to angle from the vertical direction and deflect into the lock opening as the second joint portion translates along the vertical direction relative to the groove.

12. The handhole of claim 6, wherein the tab is configured to position an upper end toward the lock opening and a lower end attached to the first wall.

13. The handhole of claim 12, wherein the lower end of the tab contacts the second joint portion at the lock opening before the upper end of the tab when the groove at the first wall is translated along the vertical direction around the second joint portion at the second wall.

14. The handhole of claim 1, wherein the first wall and the second wall comprise a thermoplastic polymer.

15. The handhole of claim 1, wherein the first wall is a unitary structure separate from the second wall forming a separate unitary structure.

16. The handhole of claim 1, wherein the first wall comprises an attachment surface, the attachment surface comprising a recess extending along the vertical direction.

17. The handhole of claim 1, wherein the first wall comprises an attachment surface, the attachment surface comprising a protrusion extending along the vertical direction.

18. The handhole of claim 1, wherein one or both of the first wall or the second wall comprises a platform extending into a volume formed by the first wall and the second wall.

19. A handhole assembly, comprising:
a pair of first walls, wherein the first wall comprises a first joint portion, the first joint portion forming a groove and an opening extending along a vertical direction; and
a pair of second walls, wherein the second wall comprises a second joint portion, the second joint portion comprising a member extendable into the groove through the opening at the first joint portion,
wherein the first wall and the second wall are connectable together at the first joint portion and the second joint portion to form a tongue and groove joint at which the first wall and the second wall are directly coupled to one another.

20. The handhole assembly of claim 19, wherein the first wall and the second wall are connectable together by sliding the groove along the vertical direction at the first joint portion over the second joint portion.
